(19) United States
(12) Patent Application Publication
(10) Pub. No.: US 2023/0196686 A1
(43) Pub. Date: Jun. 22, 2023

(54) Social Media Platform Checkout for Artificial Reality Platform-Specific Applications

(71) Applicant: Meta Platforms Technologies, LLC, Menlo Park, CA (US)

(72) Inventors: Jiakang LU, San Mateo, CA (US); Yuan CHANG, Sunnyvale, CA (US); Kenneth Andrew SHEEDLO, Arvada, CO (US); Vaishali PAREKH, San Francisco, CA (US)

(21) Appl. No.: 17/559,399

(22) Filed: Dec. 22, 2021

(51) Int. Cl. G06T 19/00; G06F 16/21; G06Q 50/00

(52) U.S. Cl. CPC G06T 19/006; G06F 16/211; G06Q 50/01

(57) ABSTRACT

An internal check-out system can coordinate between A) a provisioning system for artificial reality platform-specific applications and B) a social media platform, for providing an application check-out pipeline that's executed internally to the social media platform but in the context of the artificial reality platform. The social media platform can provide content items, related to applications that can be executed on the artificial reality platform, with links for the user to acquire the application. When the user accesses such a link, the internal check-out system can use a link to acquire a context of the artificial reality platform, useable by the social media platform. The internal check-out system can then provide a view, from within the social media platform, to a check-out service for the selected artificial reality platform application. Following the checkout, the application can be automatically installed on an artificial reality device.

### TECHNICAL FIELD

The present disclosure is directed to coordinating between a provisioning system for artificial reality platform-specific applications and a social media platform for a more efficient and engaging check-out process.

### BACKGROUND

The Internet has made it possible for people to connect and share information globally in ways previously undreamt of. Social media platforms, for example, enable people to collaborate on ideas, discuss current events, and find old friends. In fact, social networking has become one of the dominant ways people gather information and communicate. As the popularity of social networking has grown, social networking sites have attracted billions of users across the world. Providing the content items (e.g., images, advertisements, videos, applications, text, friend status updates, etc.) that users find helpful or relevant increases the chance that users will appreciate and return to the social networking site in the future. Social networking sites typically have embedded content items in their pages (often referred to as a social media feed) according to a current user's interest or context, such as where the user lives, what the user does for a living, or what devices the user has.

However, when a user interacts on a social media platform with a content item that links to an external service, the user may become less interested in pursuing the link due to the change of service providers away from the social media platform. In addition, the user may be less likely to return to the social media platform after interacting with the external service. Each of which may reduce overall interest in either the content item or social media platform.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for coordinating a check-out process between a provisioning system for platform-specific applications and a social media platform.

FIG. 6 is a flow diagram illustrating a process used in some implementations of the present technology for an artificial reality device to automatically install platform-specific applications acquired through an external check-out process.

FIG. 7 is a conceptual diagram illustrating an example user interface with a content item, in a social media feed, identifying an artificial reality platform-specific application.

FIGS. 8A-8C are conceptual diagrams illustrating an example view with user interfaces in an application check-out pipeline.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to an internal check-out system that coordinates between a provisioning system and a social media platform to provide platform-specific applications to an artificial reality device, without a user having to leave the social media platform. The user may be accessing the social media platform through an application (“app”) on a mobile device, through a webpage interface, in a virtual environment, etc., and the social media platform may have a record of the user owning or otherwise having an account for an artificial reality platform. Thus, the social media platform can determine that the user may be interested in receiving content items related to applications that can be executed on the artificial reality platform. The social media platform may imbed such content items in the user interface (UI) of the social media platform for the user, with links for the user to acquire the application.

In existing systems, when the user access such a link, the system will take the user to a third-party provisioning system, for the artificial reality platform, to acquire the application and install it on the user's artificial reality device. However, the internal check-out system described herein can instead coordinate with the provisioning system to create a view into a check-out process, for the artificial reality platform-specific application, that is internal to the social media system. This allows both more likely completion of the check-out process and better re-engagement with the social media system after the check-out process.

The coordination provided by the internal check-out system, between the provisioning system and the social media platform, can include using a link between the account of the user on the social media platform and the account of the user on the artificial reality platform, allowing code to be executed from the context of the artificial reality application provisioning system. With this “execution context,” or simply “context,” this code can then be executed in a view within the social media platform (e.g., in a lightbox, pop-up, new window, etc.) to provide a check-out service for a selected artificial reality platform application. The user can access this view to complete the check-out process. This can cause the selected artificial reality application to be added to an install queue for the user's artificial reality device. Upon completion of the check-out process, the view can close, returning the user to where she left off on the social media platform.

The acquired application can be automatically installed on the artificial reality device by the artificial reality device checking the install queue in response to various triggers (e.g., a timer expiring, on startup, through a user command, etc.) The artificial reality device can identify which application is next in the install queue, ensure sufficient space is available on the artificial reality device for that application, and automatically install the application.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

In existing systems, when a user is browsing on a social media platform and sees a content item linked to acquiring an artificial reality application, selecting the content item typically takes the user to an external system. This transition to an external system very often causes the user not to proceed with the acquisition of the artificial reality application. If the user decides to proceed, the user is taken through a check-out process in the external system (i.e., an artificial reality provisioning system) to execute the processes necessary from within that external system to acquire the application and have it installed on her artificial reality device. When the user is finished with the external system (either because the user decided not to continue with the check-out process or completed it), the user, having left the social media platform, will often not return to it right away.

The internal check-out system and processes described herein are expected to overcome these limitations of existing systems by coordinating between a provisioning system for artificial reality platform-specific applications and a social media platform. Using a link between the provisioning system and the social media platform, this coordination provides the social media platform the ability to locally execute code from the context of the provisioning system. This then allows the social media platform to provide the check-out process for the artificial reality platform-specific application, without the user having to exit the social media platform. Thus, the user doesn't experience a transition to an external system, increasing the likelihood the user will complete the check-out process. Further, when the user is finished with the check-out process, the user is still on the social media platform, allowing her to return to where she was in her interactions with the social media platform, increasing the likelihood that the user will continue to engage with the social media platform.

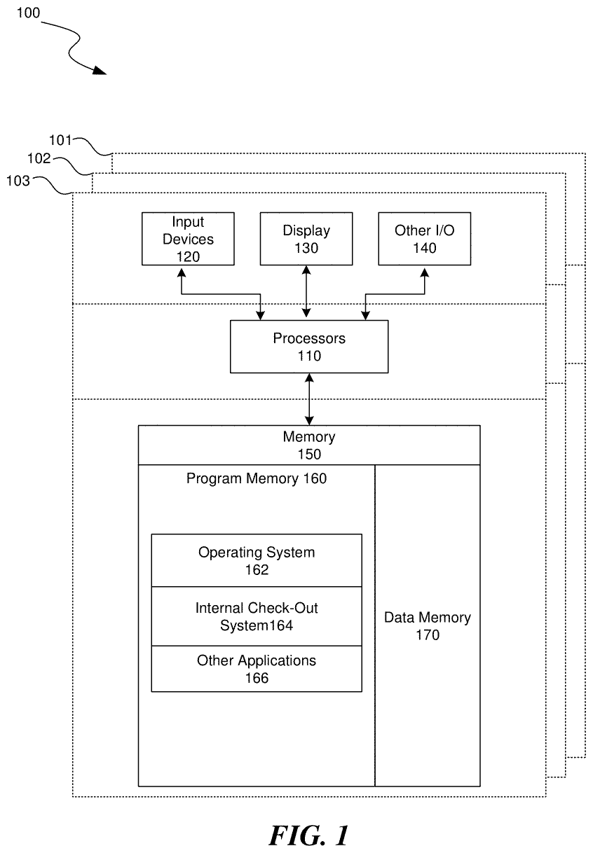

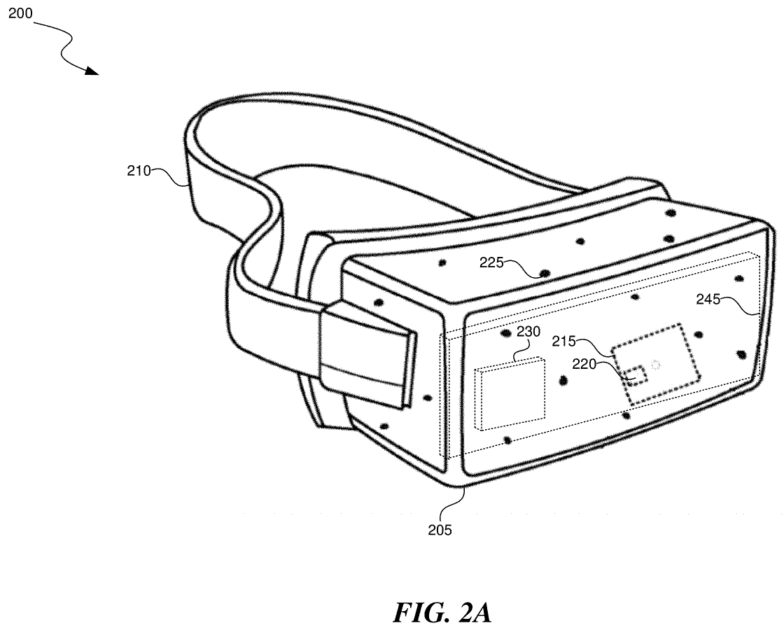

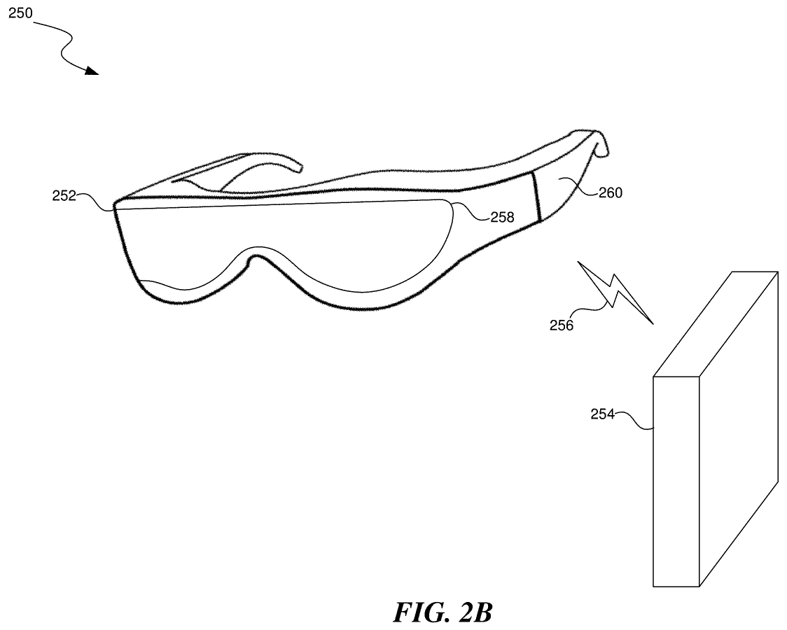

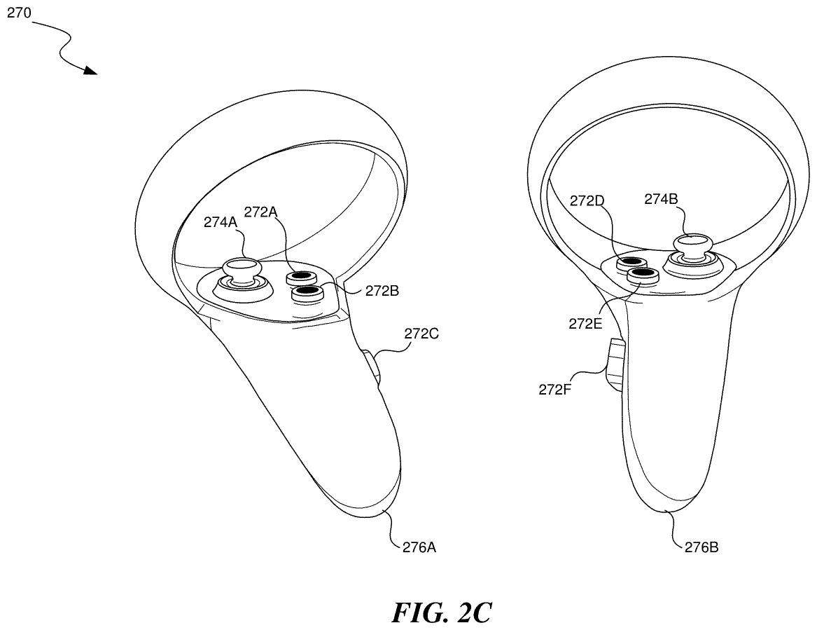

Several implementations are discussed below in more detail in reference to the figures. FIG. 1 is a block diagram illustrating an overview of devices on which some implementations of the disclosed technology can operate. The devices can comprise hardware components of a computing system 100 that can coordinate between a provisioning system for artificial reality platform-specific applications and a social media platform for providing an application check-out pipeline that's executed internally to the social media platform but in the context of the artificial reality platform. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, internal check-out system 164, and other application programs 166. Memory 150 can also include data memory 170 that can include e.g., associations between a user and an artificial reality platform, content items identifying artificial reality platform-specific applications, links between users' social media accounts and artificial reality platform accounts, check-out pipeline code and UIs, install queue details, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270, which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

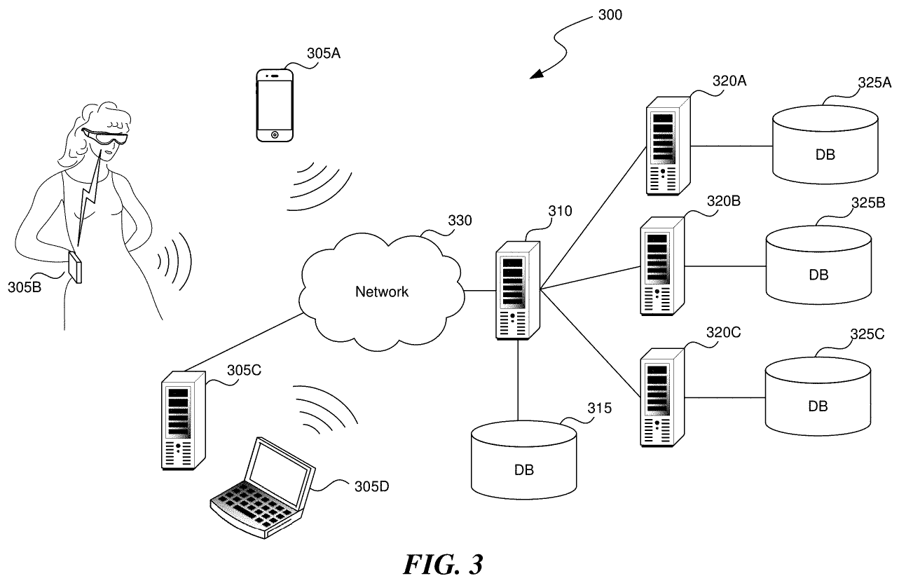

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

In some implementations, servers 310 and 320 can be used as part of a social network. The social network can maintain a social graph and perform various actions based on the social graph, A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In some implementations, the social networking system can keep records of which hardware devices and/or platforms a user uses. For example, the social networking system can track whether a user has an artificial reality device, what types of artificial reality applications the user tends to interact with, etc. hi some cases, a user's node on the social graph can specify the user's hardware devices or have edges linking the user to these devices.

A user can also, in some implementations, interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

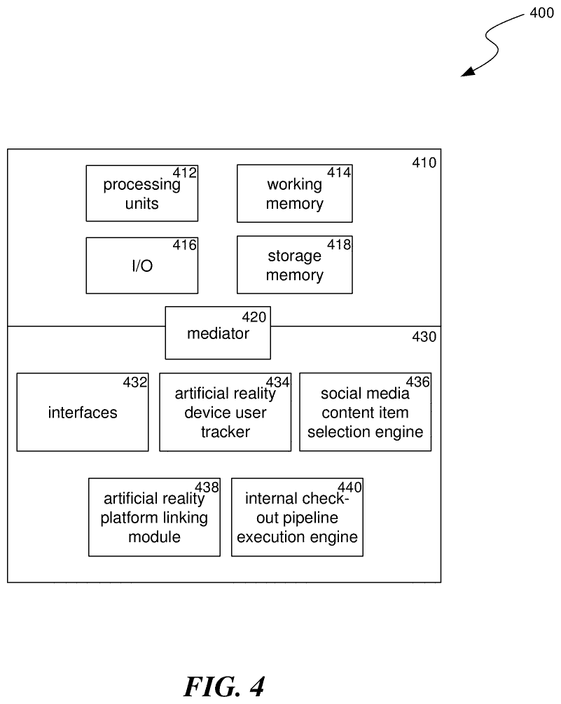

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for coordinating between a provisioning system for artificial reality platform-specific applications and a social media platform for providing an application check-out pipeline that's executed internally to the social media platform but in the context of the artificial reality platform. Specialized components 430 can include an artificial reality device user tracker 434, a social media content item selection engine 436, an artificial reality platform linking module 438, an internal check-out pipeline execution engine 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

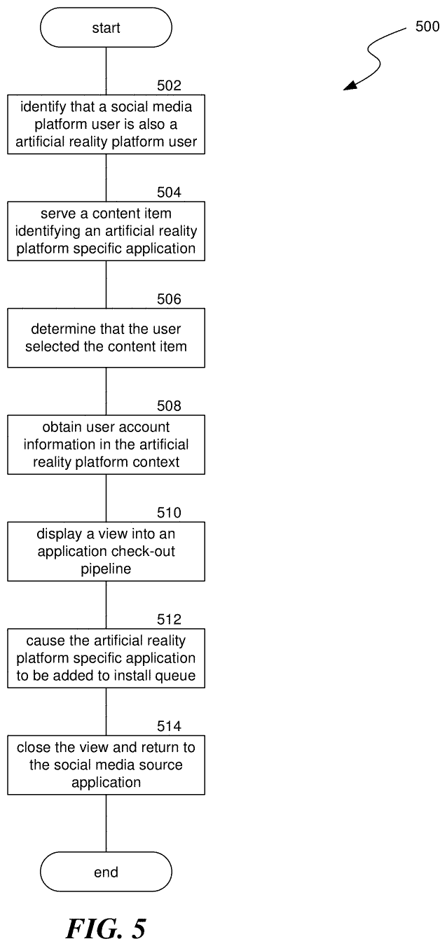

The artificial reality device user tracker 434 can determine whether a current user of a social media platform is also a user of an artificial reality platform or is otherwise associated with artificial reality devices. In various implementations, the artificial reality device user tracker 434 can accomplish this by accessing records of: the user having created an artificial reality platform account and linking it to the social media platform, the user purchasing an artificial reality device on or in relation to the social media platform, the user manually linking the artificial reality device to the social media platform, etc. Additional details on tracking whether a user is associated with an artificial reality device are provided below in relation to block 502 of FIG. 5.

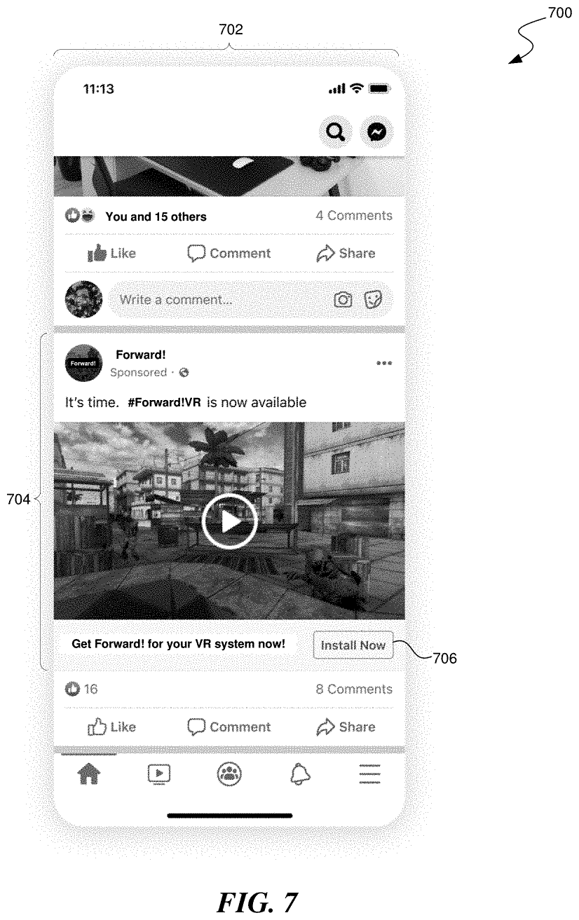

The social media content item selection engine 436 can, in response to the artificial reality device user tracker 434 determining that a current user is associated with an artificial reality device, select content items, to include in a UI of the social media platform, that identify an artificial reality platform-specific application and include a link to acquire that application. Additional details on providing content items, for artificial reality applications, on a social media platform are provided below in relation to FIG. 7 and block 504 of FIG. 5.

The artificial reality platform linking module 438 can use a link defined between the social media platform and the artificial reality platform to obtain execution scope or “context” of the social media platform. This context allows the social media platform to execute code, written to use data objects of the artificial reality platform, such as code for an application provisioning system. Additional details on obtaining a context of the artificial reality platform for local execution of artificial reality platform code within the social media platform are provided below in relation to block 508 of FIG. 5.

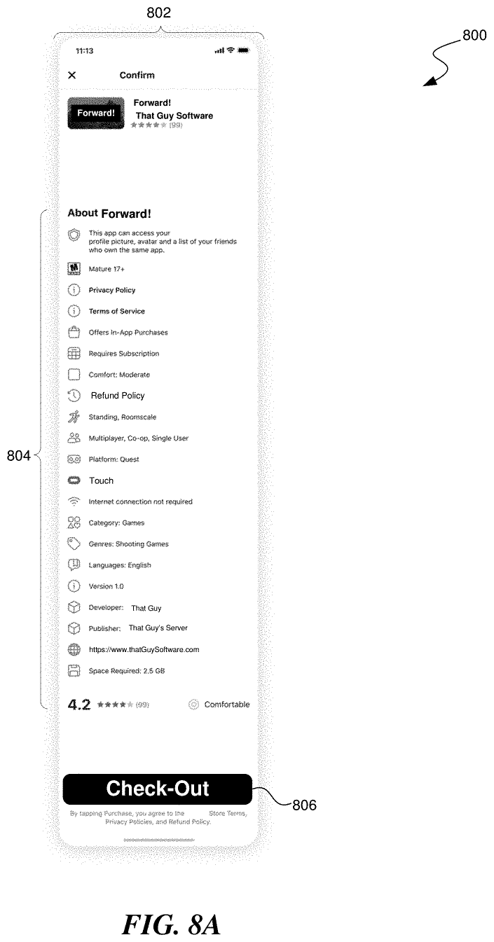

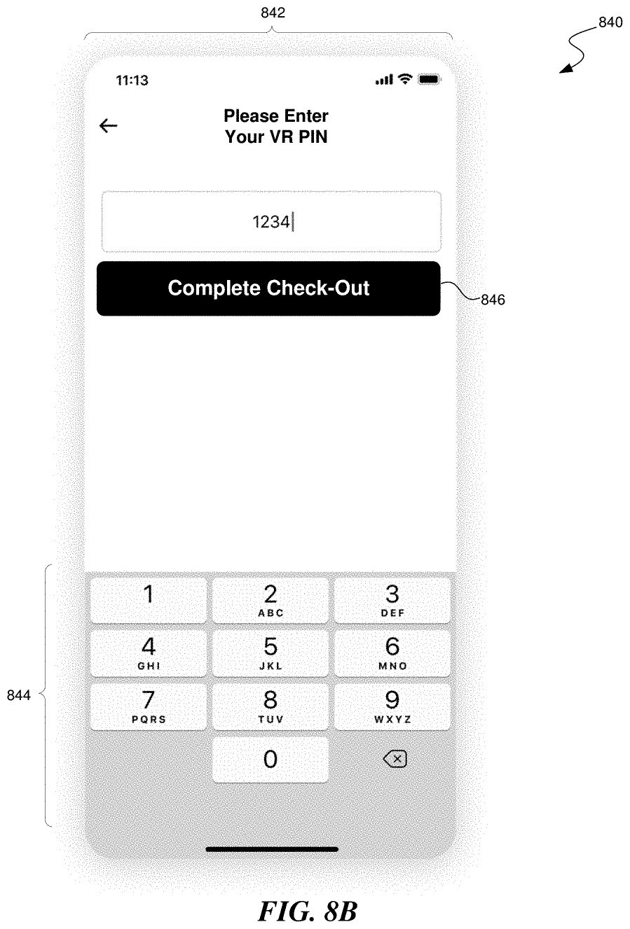

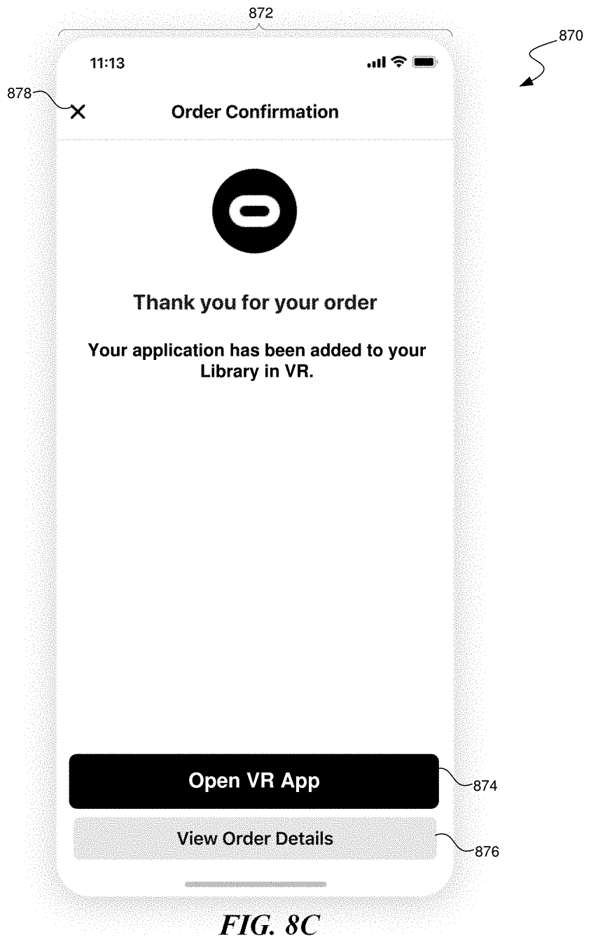

The internal check-out pipeline execution engine 440 can use the context obtained by artificial reality platform linking module 438 to execute code, for a check-out pipeline of an artificial reality application provisioning system, internally by the social medial platform. Additional details on using the artificial reality platform context to execute artificial reality platform code of an application provisioning system are provided below in relation to FIGS. 8A-8C and blocks 510 and 512 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations of the present technology for coordinating a check-out process between a provisioning system for platform-specific applications and a social media platform. As used herein, an application that is “specific” to the artificial reality platform (and similar language) refers to an application that can be executed on an XR device associated with the artificial reality platform. Whether or not the application can be executed in other systems is not relevant to whether the application is specific to the artificial reality platform. Process 500 can be performed on a social media platform, which can include one or both of server-side execution and/or client-side execution. In some implementations, process 500 can be initiated as part of a social media process that selects content items to display to a user.

At block 502, process 500 can identify that a user on a social media platform is also a user of an artificial reality platform. In various cases, process 500 can accomplish this by accessing records of: the user having created an artificial reality platform account and linking it to the social media platform, the user having accessed content related to artificial reality devices, the user purchasing an artificial reality device on or in relation to the social media platform, the user accessing the social media platform while using an artificial reality device, the user manually linking the artificial reality device to the social media platform, etc.

At block 504, process 500 can serve, in a social source application, a content item identifying an application specific to the artificial reality platform. The social source application can be any of various access points to the social media platform such as a webpage, mobile device app, artificial reality device application, etc. The content item can be provided, for example, as part of a user's feed; in a side bar; as a pop-up, lightbox, or other overlay; in a notification bar; etc. In various implementations, the content item can be a notification, advertisement, video, image, infotainment piece, news article, etc. In some cases, the content item can include a link or other selection option, such as a “Install Now” or “Buy App” button. An example of a content item with a link to obtain an artificial reality application is provided in FIG. 7.

At block 506, process 500 can determine that the user selected the content item. For example, the user can click the link or other selection option, make a gesture or provide a voice command indicating the content item, have her gaze linger on the content item for above a threshold amount of time, etc.

At block 508, process 500 can obtain user account information in the artificial reality platform context by using a link between an account for the current user on the social media platform and an account for the user on the artificial reality platform. In some implementations, a mono-schema can be applied between the social media platform and the artificial reality platform, allowing the social media platform to perform queries against the artificial reality platform (e.g., using a GraphQL architecture). This provides the social media platform the context (e.g., a React context or other data scoping) of the artificial reality platform, allowing the social media platform to execute code that expects the data objects available in the artificial reality platform. In some cases, the link between the social media platform and the artificial reality platform can allow the social media platform to get the artificial reality platform without the user having to provide credentials or otherwise sign into the artificial reality platform.

At block 510, process 500 can display a view into an application check-out pipeline where the user completes acquisition of the application specific to the artificial reality platform. The view into the check-out pipeline can be provided in the source social media application, e.g., as a replacement of the content item, in a lightbox, popup, side bar, notification bar, or other overlay, in a new window, etc. For example, React checkout code, from provisioning system of the artificial reality platform, can be obtained and, with the context obtained in block 508, run natively in the social media source application. In various cases, the check-out pipeline can include one or multiple steps, such as an application information UI, a PIN or other credential verification UI, and a confirmation UI. An example of UIs that can be used in a checkout pipeline is provided in FIGS. 8A-8C.

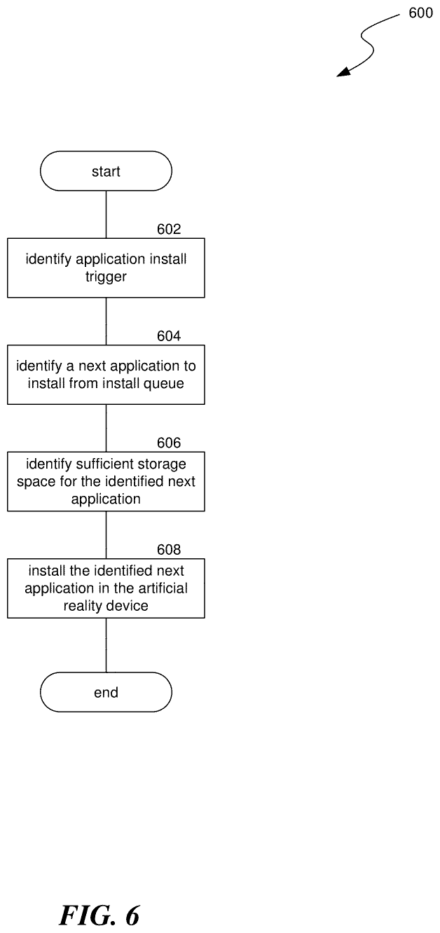

At block 512, process 500 can cause the application specific to the artificial reality platform to be added to an install queue for the user on the artificial reality platform. An install queue can be a queue (e.g., FIFO or user organized), for a particular artificial reality device or artificial reality platform account, listing applications that should be installed on an artificial reality device in response to an installation trigger and as space is available. Adding an indication of an application to an install queue can cause the application to be automatically installed on an artificial reality device for the user. Further details on automatically adding an application to an artificial reality device based on an install queue are provided in relation to FIG. 6.

At block 514, process 500 can close the view and return to the social media source application. Because the view was implemented from within the social media platform and closing the view can include, for example, closing a pop-up, lightbox, tab, window, overlay or other side-view. Closing the view takes the user back to the same place in the social media source application the user was at prior to selecting the content item. In some cases, a user may exit the check-out pipeline before completing checkout, in which case block 512 can be skipped before moving to block 514. Once the view is closed, process 500 can end.

FIG. 6 is a flow diagram illustrating a process 600 used in some implementations of the present technology for an artificial reality device to automatically install platform-specific applications acquired through an external check-out process. In some implementations, process 600 can be performed on an artificial reality device: when the device is started, e.g., as part of the device's operating system; when an artificial reality environment is initialized and under a system in control of the artificial reality environment (i.e., a “shell” system); or as part of executing a third-party application.

At block 602, process 600 can identify an application install trigger. In various implementations, the install trigger can be one of various events such as the artificial reality device starting up, when a periodic timer expires, in response to a notification from the install queue that an item has been added to it, etc.

At block 604, process 600 can identify a next application to install from the install queue. In various implementations, the install queue can be a first-in-first-out (FIFO) queue and/or a user-customizable list of applications to install on a user's artificial reality device. In some cases, the install queue can be device-specific or can be for all artificial reality devices linked to the same artificial reality platform account. The next application selected can be the application at the top of this queue.

At block 606, process 600 can identify whether there is sufficient storage space for the identified next application. If there is not enough storage space to install the identified next application, process 600 can free up space. This can be done automatically (e.g., removing least-used or least-recently-used application(s)) or by notifying the user to free up space. At block 608, process 600 can install the identified next application in the artificial reality device. Process 600 can then end (to be executed again upon a next install trigger).

FIG. 7 is a conceptual diagram illustrating an example 700 user interface with a content item, in a social media feed, identifying an artificial reality platform-specific application. In example 700, a user is viewing a social media feed 702 on a mobile device. The social media platform has determined that the user has an artificial reality device, and in response, included content item 704 in the feed identifying a “Forward!” artificial reality platform-specific application. The content item 704 also includes an “Install Now” button 706, which the user can select to begin a check out process for the “Forward!” artificial reality platform-specific application.

FIGS. 8A-8C are conceptual diagrams illustrating examples 800, 840, and 870 of a view with user interfaces in an application check-out pipeline. Example 800 illustrates a first user interface 802 in the application check-out pipeline, where information 804 about the artificial reality platform-specific application is provided and a “Check-Out” button 806 allows the user to progress in the application check-out pipeline. Tapping the “Check-Out” button 806 moves the user to example 840, which illustrates a second user interface 842 in the application check-out pipeline, where a PIN confirmation screen is provided for a user to enter, with controls 844, her artificial reality platform PIN, and press “Complete Check-Out” button 846 to confirm acquisition of the artificial reality platform-specific application. Because the social media platform has used a link to the artificial reality platform's provisioning system, the user's entered PIN can be verified by the social media platform executing code in the context of the artificial reality platform. After the PIN is successfully confirmed, the application check-out pipeline can proceed to example 870, where a confirmation user interface 872 is presented and the acquired artificial reality platform-specific application is added to an install queue. From the confirmation user interface 872, the user can select button 874 to open a local application of the artificial reality platform, select button 876 to review details of the ordered artificial reality platform-specific application, or select control 878 to close the view into the application check-out pipeline—which would return the user to where she left off in the social media feed of example 700.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for coordinating between A) a provisioning system for artificial reality platform-specific applications and B) a social media platform, for providing an application check-out pipeline that's executed internally to the social media platform but in the context of an artificial reality platform, the method comprising:
identifying that a user of the social media platform is associated with the artificial reality platform and/or with an artificial reality device;
serving a content item, to the user via a user interface of the social media platform, that identifies an application specific to the artificial reality platform;
identifying that the user made a selection in relation to the content item;
obtaining an execution context, of the provisioning system, useable by the social media platform;
using the execution context to provide, from within a social source application connecting to the social media platform, a view into an application check-out pipeline for acquisition of the application specific to the artificial reality platform, wherein the application check-out pipeline is configured to access data objects of the provisioning system; and
in response to completion of the application check-out pipeline:
adding the application specific to the artificial reality platform to an install queue for an artificial reality device of the user; and
closing the view such that the user is returned to a place in the social source application the user was at prior to making the selection in relation to the content item.

2. The method of claim 1, wherein the content item includes a link for the user to acquire the application specific to the artificial reality platform and wherein the selection in relation to the content item is an activation of the link.

3. The method of claim 1, wherein obtaining the execution context comprises using a link defined, for the user, between the social media platform and the artificial reality platform to obtain an execution scope of the provisioning system.

4. The method of claim 1, wherein obtaining the execution context comprises obtaining a React context of the provisioning system.

5. The method of claim 1, wherein the social media platform and artificial reality platform use a mono-schema allowing the social media platform to perform queries against the artificial reality platform in the execution context.

6. The method of claim 1, wherein the application check-out pipeline includes an authentication process, wherein the user provides a credential to authorize acquisition of the application specific to the artificial reality platform.

7. The method of claim 1,
wherein social source application is being executed on a device other than the artificial reality device of the user; and
wherein the adding the application specific to the artificial reality platform to the install queue causes the application specific to the artificial reality platform to be automatically installed on the artificial reality device of the user.

8. A computer-readable storage medium storing instructions that, when executed by a computing system, cause the computing system to perform a process for coordinating between a provisioning system for artificial reality platform-specific applications and a social media platform, the process comprising:
identifying that a user made a selection in relation to a content item identifying an application specific to an artificial reality platform;
obtaining an execution context of the provisioning system;
using the execution context to provide, from within a social source application connecting to the social media platform, a view into an application check-out pipeline for acquisition of the application specific to the artificial reality platform; and
in response to completion of the application check-out pipeline:
adding the application specific to the artificial reality platform to an install queue for an artificial reality device of the user; and
closing the view such that the user is returned to a place in the social source application the user was at prior to making the selection in relation to the content item.

9. The computer-readable storage medium of claim 8, wherein the process further comprises:
identifying that a user of the social media platform is associated with the artificial reality platform and/or with an artificial reality device; and
in response, serving the content item, to the user via a user interface of the social media platform.

10. The computer-readable storage medium of claim 8, wherein the application check-out pipeline is configured to access data objects of the provisioning system.

11. The computer-readable storage medium of claim 8,
wherein social source application is being executed on a device other than the artificial reality device of the user; and
wherein the adding the application specific to the artificial reality platform to the install queue causes the application specific to the artificial reality platform to be automatically installed on the artificial reality device of the user.

12. The computer-readable storage medium of claim 8, wherein the content item includes a link for the user to acquire the application specific to the artificial reality platform and the selection in relation to the content item is an activation of the link.

13. The computer-readable storage medium of claim 8, wherein obtaining the execution context comprises using a link defined, for the user, between the social media platform and the artificial reality platform to obtain an execution scope of the provisioning system.

14. The computer-readable storage medium of claim 8, wherein obtaining the execution context comprises obtaining a React context of the provisioning system.

15. The computer-readable storage medium of claim 8, wherein the social media platform and artificial reality platform use a mono-schema allowing the social media platform to perform queries against the artificial reality platform in the execution context.

16. The computer-readable storage medium of claim 8, wherein the application check-out pipeline includes an authentication process wherein the user provides a credential to authorize acquisition of the application specific to the artificial reality platform.

17. A computing system for coordinating between a provisioning system for artificial reality platform-specific applications and a social media platform, the computing system comprising:
one or more processors; and
one or more memories storing instructions that, when executed by the one or more processors, cause the computing system to perform a process comprising:
identifying that a user made a selection in relation to a content item identifying an application specific to an artificial reality platform;
obtaining an execution context of the provisioning system;
using the execution context to provide, from within a social source application connecting to the social media platform, a view into an application check-out pipeline for acquisition of the application specific to the artificial reality platform; and
in response to completion of the application check-out pipeline:
adding the application specific to the artificial reality platform to an install queue for an artificial reality device of the user; and
closing the view such that the user is returned to a place in the social source application the user was at prior to making the selection in relation to the content item.

18. The computing system of claim 17, wherein the application check-out pipeline is configured to access data objects of the provisioning system.

19. The computing system of claim 17,
wherein social source application is being executed on a device other than the artificial reality device of the user; and
wherein the adding the application specific to the artificial reality platform to the install queue causes the application specific to the artificial reality platform to be automatically installed on the artificial reality device of the user.

20. The computing system of claim 17, wherein the social media platform and artificial reality platform use a mono-schema allowing the social media platform to perform queries against the artificial reality platform in the execution context.
